(19) United States
(12) Patent Application Publication
(10) Pub. No.: US 2012/0189321 A1
(43) Pub. Date: Jul. 26, 2012

(54) Dual Drive Externally Modulated Laser

(75) Inventors: James Whiteaway, Sawbridgeworth (GB); Theodor Kupfer, Feucht (DE); Christian Raabe, Nurenberg (DE)

(73) Assignee: CISCO TECHNOLOGY, INC., San Jose, CA (US)

(21) Appl. No.: 13/387,155

(22) PCT Filed: Oct. 8, 2010
(86) PCT No.: PCT/IB10/54558

§ 371 Date: Jan. 26, 2012

(30) Foreign Application Priority Data
Oct. 14, 2009 (GB) 0917978.9

(51) Int. Cl. H04B 10/04

(52) U.S. Cl. 398/183

(57) ABSTRACT

A method of generating a signal in an optical transmitter comprising a directly modulated laser and an amplitude modulator for modulating the output of the laser. The method comprises the steps of applying a first modulation signal representing data to be transmitted to the current of the laser such that the output frequency of the laser is modulated, and applying a second modulation signal representing the data to be transmitted to the amplitude modulator such that the amplitude of the laser output is modulated.

### BACKGROUND

This invention relates to the modulation of an optical source in a transmitter for an optical communications system, and in particular to synchronised amplitude and frequency modulation of that optical source.

Optical communications systems utilise a modulated optical source for the transmission of data. A range of modulation formats are utilised, including amplitude and phase modulation. An optical source is modulated and the modulated light is transmitted through an optical fibre to a receiver where the light is detected and the modulation decoded.

Amplitude modulation may be produced by direct modulation of the current supplied to the laser, or by the use of an external optical modulator. In general, direct modulation provides a poorer quality optical signal than an externally modulated laser due to phase and frequency modulation effects that are inseparable from the amplitude modulation. A directly modulated DFB laser can typically only provide a transmission distance of around 20 km of standard fibre at 10 Gb/s with a hard decision receiver. The use of an external optical modulator with a Continuous Wave (CW) laser source allows an improvement in signal quality and hence an increase in transmission distance. For example, a LiNbO₃ Mach-Zehnder modulator may provide a transmission distance of around 80 km of standard fibre at 10 Gb/s. However, LiNbO₃ modulators are expensive, physically large and require large drive voltages. These attributes make them unattractive for reducing the cost of optical transmissions systems.

Electro-absorption modulators may allow a similar reach to LiNbO₃ modulators, but are again more expensive than a directly modulated laser and the components are wavelength sensitive, thus requiring a different design of device for each optical channel. The Required Optical Signal to Noise Ratio OSNR (ROSNR) for externally modulated CW lasers is typically a strong function of chromatic dispersion (CD). That is, ROSNR increases rapidly for small variations in CD away from the optimum value (which may be zero dispersion) and thus optical chromatic dispersion compensation must be very closely matched to the actual CD of the system.

Dispersion compensation allows transmission distances to be extended by compensating for chromatic dispersion of the transmission fibre. That compensation is generally provided by Dispersion Compensating Fibre, whose dispersion slope is the reverse of the transmission fibre, or by the use of a dispersion compensating grating or other similar device. Optical dispersion compensation is both expensive and difficult to implement due to the cost of the fibre, the requirement to match the compensation to the transmission fibre, and the need to overcome the additional losses of the dispersion compensation devices. Dispersion compensation can also be provided electronically using signal processing systems at the receiver, but such systems are relatively expensive and complex to implement, but may be cheaper than optical compensation.

Since chromatic dispersion is a linear effect the expected dispersion for a given system can be predicted relatively accurately. The expected dispersion can be utilised to generate a pre-compensated signal that is ‘unwound’ by the dispersion of the transmission fibre such that an undistorted waveform is received at the receiver. Generally, complex amplitude and phase modulation patterns are required, which are complex and expensive to produce. Furthermore, non-linear effects in the fibre, for example Polarisation Mode Dispersion (PMD) limit the effectiveness of this technique. PMD also generally varies on a millisecond timescale, which presents difficulties in any control system for a pre-compensation process.

Alternative modulation techniques, such as Optical Duobinary (ODB), which limits the spectral width of the transmitted waveform, may be utilised to increase the transmission distance, but they are generally expensive and complex to implement.

It has been demonstrated that transmission distance can be extended by applying an adiabatic frequency chirp of 50% of the bit rate between the ‘ones’ and ‘zeros’ of the optical carrier. This is due to the adiabatic frequency chirp at half the bit rate giving rise to a ρ radians or 180° relative phase shift in the optical carrier, over a bit period, when switching from a ‘0’ to a ‘1’, or vice versa. This is sometimes referred to as minimum shift keying (MSK), and for example results in a phase inversion between the in a ‘101’ bit sequence. In the time domain, after chromatic dispersion, this leads to destructive interference of the energy spreading from the into the ‘0’ bit slot. Alternatively, in the frequency domain we observe a narrowing in the optical spectrum which increases the tolerance to chromatic dispersion. These properties are similar to those exhibited by ODB modulation, but without the requirement for pre-coding.

Direct modulation of semiconductor lasers produces frequency modulation in addition to the desired amplitude modulation, due to the modulation of the carrier density, and hence the refractive index of the semiconductor material, as the current is modulated. At low bias voltage and high extinction ratio (ER), the laser exhibits strong damped oscillatory transient effects, in power and optical frequency, at ‘0’ to ‘1’ transitions, and vice versa. In addition, since the intra-band carrier relaxation time is significant, non-linear gain effects are observed at high photon density when the stimulated emission rate is high. This has the effect of requiring a higher carrier density at high output power so as to maintain the required gain in the laser cavity, which in turn modifies the refractive index. The effect is to introduce the so-called adiabatic frequency chirp which modulates the frequency between the ‘1’s and ‘0’s. At low ER values, as used for MSK, transient frequency effects are relatively weak, and it is the adiabatic frequency chirp which dominates. The frequency chirp is linked to the amplitude modulation by the material used in the active region of the laser, and by the design of the laser. For a typical laser, an extinction ratio of around 3 dB is provided when the laser is driven to provide a 5 GHz frequency modulation on a 10 Gb/s signal at standard output powers. This ER is relatively low and leads to system performance degradation as a high OSNR is required to achieve a low Bit Error Rate (BER).

The extinction ratio of a directly modulated laser providing a 50% frequency chirp has been improved by using a narrow optical filter at the output of the laser, offset from the central frequency of the laser. The frequency chirp causes the attenuation of the filter to vary between high and low power pulses, thus increasing the extinction ratio. The result is a transmitted waveform exhibiting adiabatic frequency chirp of half the bit rate, combined with a high ER, and low inter-bit power and optical frequency transient effects. Transmission distances of 200 km have been demonstrated using this technique, but the transmitter is complex (and hence expensive) as the filter must be controlled to maintain its alignment to the laser to an accuracy of around 1 GHz; at optical frequencies this is extremely challenging. This is made more challenging when tunable lasers are utilised as the filter must either have a free spectral range (FSR) matching the channel spacing, or be tuned to track the laser source.

There is therefore a need for a transmission system with reduced cost and/or improved performance compared to previous systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method of generating a signal in an optical transmitter comprising a directly modulated laser and an amplitude modulator for modulating the output of the laser, the method comprising the steps of applying a first modulation signal representing data to be transmitted to the current of the laser such that the output frequency of the laser is modulated, and applying a second modulation signal representing the data to be transmitted to the amplitude modulator such that the amplitude of the laser output is modulated.

The second modulation signal may be delayed compared to the first modulation signal.

The first and second modulation signals may be the same signal.

The first modulation signal may be configured to cause a frequency chirp of half the bit rate at which the transmitter is operating.

The bit rate may be at least 10 Gb/s and the frequency chirp may be approximately 50% of the bit rate.

The modulation signals may be configured such that the optical frequency modulation and amplitude modulation of the output of the amplitude modulator are substantially aligned in time.

The first modulation signal may be a current waveform and the second modulation signal may be a voltage waveform.

There is also provided a transmitter for an optical communications system, comprising a directly modulated laser, an amplitude modulator, wherein the output of the laser is optically coupled to the input of the modulator, the output of the modulator being the output of the transmitter, wherein the laser has an input for modulating the current of the laser, and the amplitude modulator has an input for modulating the amplitude of the laser output.

The modulation inputs to the laser and the amplitude modulator may be configured such that, at the output of the transmitter, frequency modulation applied by the laser is synchronised with amplitude modulation applied by the amplitude modulator.

The laser and modulator may be provided in a single package.

The modulation inputs to the laser and the modulator may be provided by a single input.

The transmitter may further comprise a delay element to delay the modulation signal to the amplitude modulator.

The bandwidth of the modulation inputs may be at least 50% of the bit rate at which the device is configured to operate.

The intrinsic laser chip bandwidth is at least 70% of the bit rate at which the device is configured to operate.

The device may be configured to operate at least 10 Gb/s.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIGS. 1 and 2 show schematic diagrams of a low cost optical transmitter for providing independent frequency and amplitude modulation;

FIG. 3 shows a schematic block diagram of an optical transmitter with signal charts;

FIG. 4 shows a graph of OSNR against system dispersion for a simulated transmission system operating at 10 Gb/s, for varying values of adiabatic frequency chirp;

FIG. 5 shows a graph of OSNR against system chromatic dispersion for a simulated transmission system operating at 10 Gb/s, for varying delay between the amplitude modulation and 5 GHz of frequency modulation;

FIG. 6 shows a schematic diagram of a tunable laser allowing independent frequency and amplitude modulation; and

FIG. 7 shows graphs of material gain and Line-width Enhancement Factor (LEF) for varying wavelengths.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

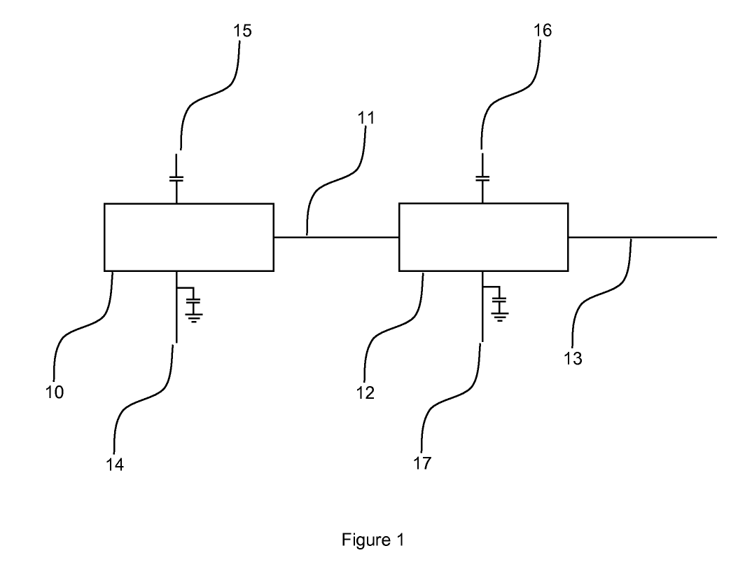

FIG. 1 shows a schematic diagram of a low cost optical transmitter for providing an amplitude and frequency modulated signal. This transmitter is particularly suitable for generating an amplitude modulated signal having a frequency chirp between the high and low power pulses. Laser 10 provides an optical output 11 to external modulator 12, whose output is coupled to fibre output 13 which forms the input to an optical transmission system.

The laser 10 has a DC input 14 for the application of a bias current, and an AC input 15 for application of a modulation signal. The modulator 12 has an AC input 16 for application of a modulation signal. A DC bias input 17 may also be provided on the modulator if the particular modulator design requires a bias to be applied for operation.

The transmitter of FIG. 1 allows the separation of amplitude and frequency modulation, without the complexity of the techniques described previously. The AC modulation input to the laser is utilised to generate the required frequency chirp, along with some amplitude modulation, and the modulator is utilised to generate additional amplitude modulation encoding the data onto the optical carrier. In particular, the transmitter allows the generation of a waveform having a frequency chirp of 50% of the bit rate to benefit from the improved performance noted above, while also providing a high extinction ratio due to the amplitude modulator.

The AC inputs 15 and 16 to the laser and modulator must have a sufficiently high bandwidth to allow the application of modulation, at the bit rate of the signal, to be transmitted to the optical signal. For example, the AC inputs 15 and 16 may require a bandwidth equal to the bit rate, or in other examples, a bandwidth of at least half the bit rate. Similarly the devices must be designed to operate at such speeds, for example with suitably low parasitic impedances and fast enough internal dynamics.

The laser 10 may have an intrinsic chip bandwidth of at least 0.7*bit rate, and a suitable high-speed connection, to allow modulation of the output frequency at the appropriate rate.

A small amount of amplitude modulation is caused by the modulation signal applied to the laser, but as described above that modulation is typically less than that provided by the modulator. The amplitude modulation at the output of the laser is also in phase with the amplitude modulation applied by the amplitude modulator. Since the sign of the frequency chirp does not affect the dispersion tolerance of the transmission system, we select current modulation to the laser and voltage modulation to the modulator that gives additive contributions to the total extinction ratio. For example, when configured to generate a 5 GHz frequency chirp, approximately 3 dB of amplitude modulation will be generated, compared to for example 10 dB provided by the amplitude modulator.

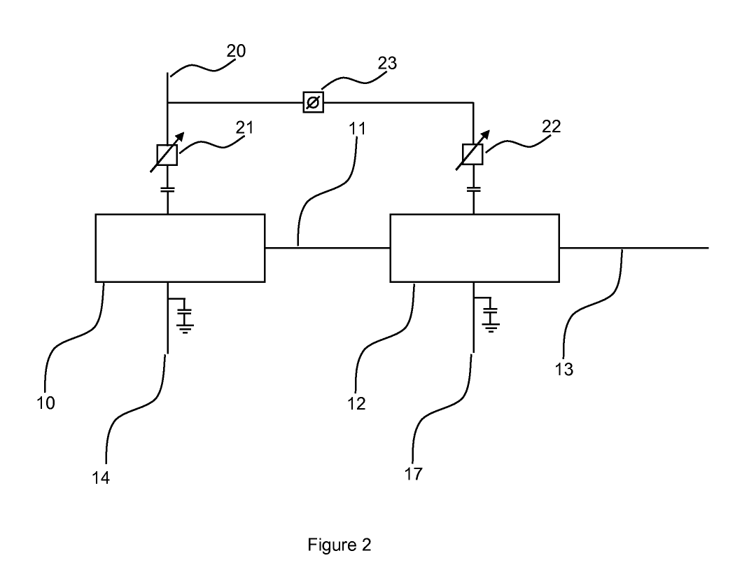

FIG. 2 shows a further schematic diagram of an embodiment of the transmitter of FIG. 1 configured to generate an optical waveform with aligned frequency chirp and amplitude modulation. A single modulation signal 20 (representing the data) is utilised and passed to the laser 10 via an amplitude adjuster 21. The signal is also fed to the amplitude modulator 12 via a second amplitude adjuster 22, and via a delay element 23 which allows the relative timing of the signals at the laser and modulator to be adjusted. By adjustment of the delay element 23 the relative timing of the amplitude modulation and frequency chirp can be varied. The amplitude adjusters 21, 22 may be, for example, variable or fixed attenuators, or variable or fixed amplifiers depending on the relative amplitude of the data signal and that required to provide the required frequency chirp and amplitude modulation. Other features shown in FIG. 2 may be provided as described in relation to FIG. 1, as demonstrated by the common reference numerals.

The modulation signal 20 is connected to the laser 10 such that it adds to a bias current applied to the laser cavity (applied via DC connection 14). That may be, for example, achieved using a bias-T arrangement to add the AC-coupled data signal to the DC bias current. A similar arrangement may be utilised for the modulator.

The amplitude adjuster 21 allows the amplitude of the modulation signal applied to the laser to be adjusted, and hence the magnitude of the frequency chirp to be adjusted to the level required. The magnitude of the modulation signal required to provide a particular chirp varies depending on the particular laser design and the bias at which the laser is being operated. Therefore a variable adjuster may be desirable.

As will be appreciated, additional electronic components may also be provided in the signal paths of the transmitter of FIG. 2 to present the drive signals to the laser and modulator in the correct format. For example, lasers generally require a current drive, whereas modulators require a voltage drive. Suitable components to provide each of these signal formats may be implemented in conventional manners. Similarly, separate signal sources may be utilised to provide the signals for each component, by modification of the transmitter of FIG. 2 to allow the laser and modulator to be driven from separate sources. The amplitude and phase adjustment shown in FIG. 2 may be provided by functionally equivalent systems, or may be provided integral to the signal sources. The operation of the system is independent of the manner of providing the signals to the laser and modulator.

Methods of operating the transmitters described with reference to FIGS. 1 and 2 will now be described.

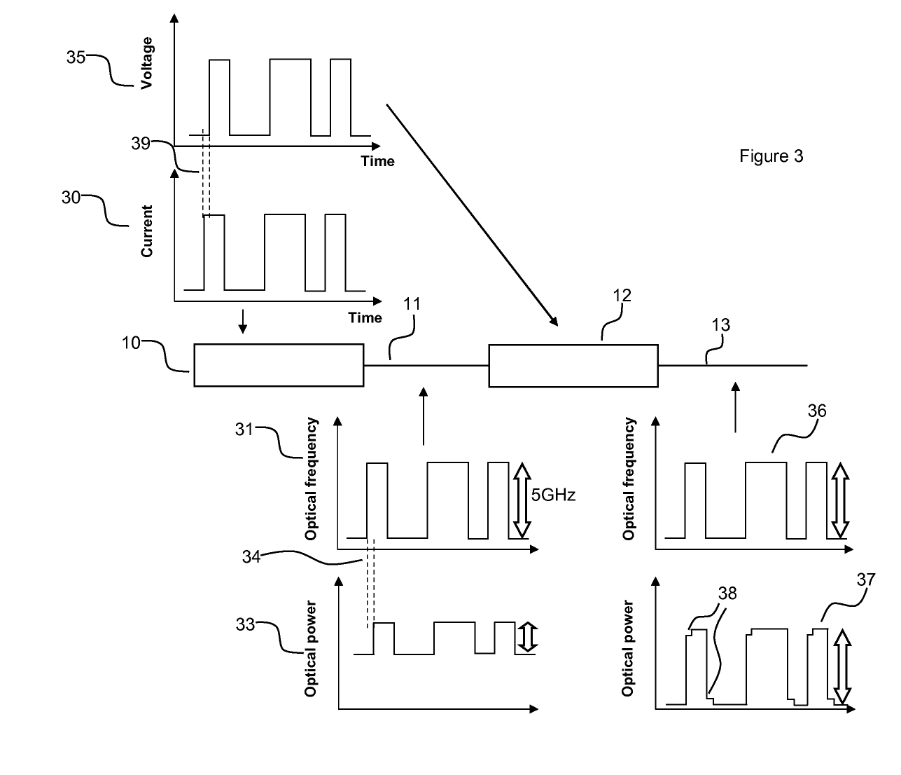

FIG. 3 shows a block diagram of the transmitters described above, together with an indication of the drive signals and optical signals at various points in the transmitter when operated to generate an optical signal having the properties described below.

A modulated current signal 30 (operation at 10 Gb/s is assumed) is applied to the laser 10 together with a DC bias current. The magnitude of the modulated signal 30 is selected to produce a 5 GHz frequency chirp between the high and low output powers as shown in the optical frequency chart 31. The current modulation 30 also produces a low extinction ratio amplitude modulation 33, of approximately 3 dB under typical conditions. The change in optical frequency leads 34 the change in optical power by a small amount (typically 25 ps) because the optical frequency is directly dependent on the carrier density, whereas the rate of change of the output power is dependent on the gain or inversion level, which is in turn is related to the carrier density.

The modulation signal 35 to the modulator 12 is delayed 39 compared to the current modulation signal 30 to the laser, such that the amplitude modulation created by the modulator is aligned with the frequency chirp created by the current modulation (since there is a finite time delay between the laser modulation current change and the change of frequency of the light arriving at the modulator). A delay of approximately 25 ps may be appropriate, but this will vary with the laser bias current and other parameters. The output of the modulator thus has a frequency chirp pattern 36 aligned with an amplitude modulation pattern 37. The small ‘notches’ 38 at the optical power transitions are due to the small change in output power 33 from the laser 10 due to the current modulation. As noted above, that small change is not aligned with the optical frequency chirp and therefore is also not aligned with the amplitude modulation applied by the modulator 12 (which is aligned with the frequency chirp), thereby causing the stepped changed in power.

The resulting waveform thus has a high extinction ratio aligned with a 5 GHz frequency chirp (for a 10 Gbit/s signal), which as will be shown may provide improved system performance. Under the considered conditions frequency chirp at 50% of the bit rate provides the optimum performance, but as will be appreciated other amounts of frequency chirp may be utilised, and can be provided using the transmitter described above. In the general sense, the transmitter allows an optical signal to be generated having synchronised amplitude and frequency modulation, and for the relative phase and amplitude of the amplitude and frequency modulation to be varied.

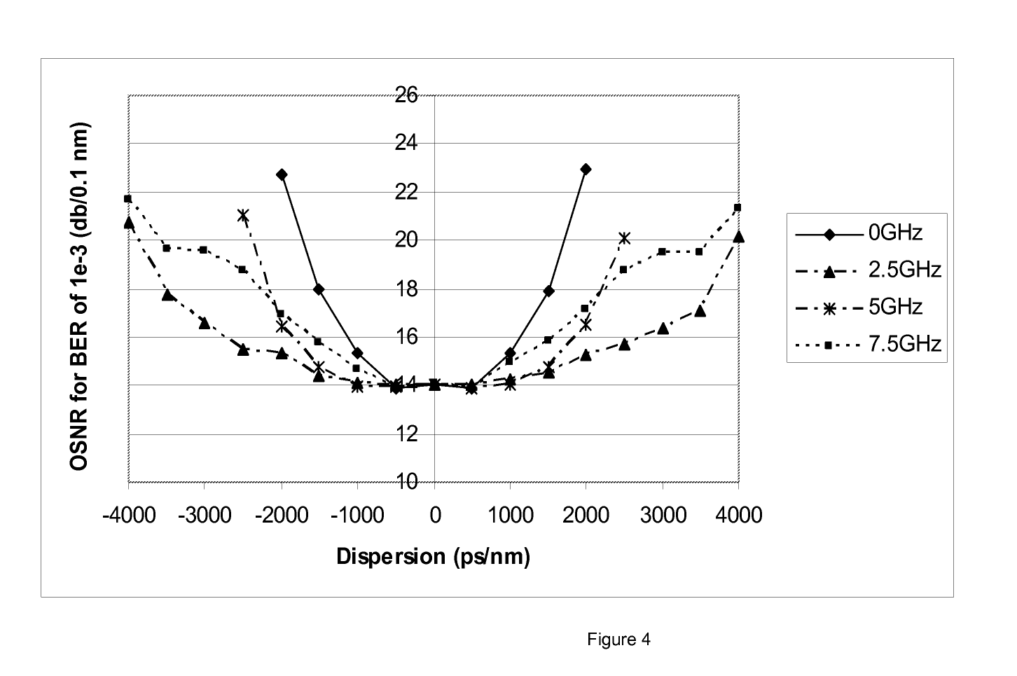

FIG. 4 shows a graph of OSNR against system chromatic dispersion for a simulated transmission system operating at 10 Gb/s, for varying values of adiabatic frequency chirp. The amplitude modulation and frequency chirp are aligned, and the modulation format is Non Return to Zero NRZ. A lower OSNR value indicates better system performance, showing that a frequency chirp of 5 GHz (50% of the bit rate) provides the best performance.

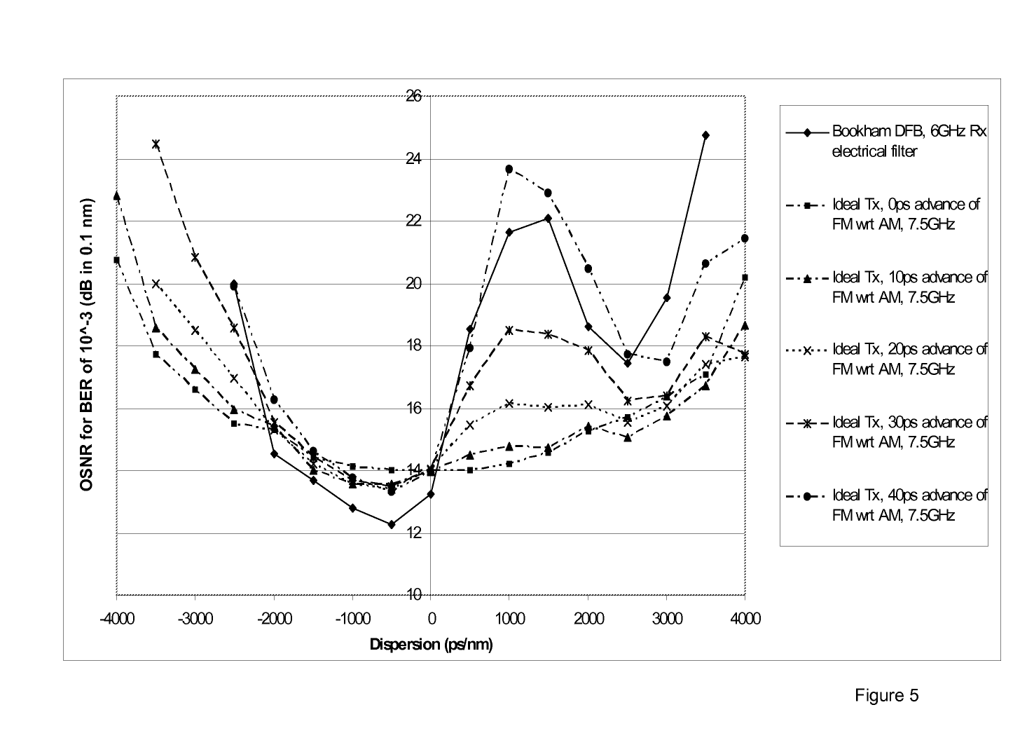

FIG. 5 shows a graph of OSNR against system chromatic dispersion for a simulated transmission system operating at 10 Gb/s, for varying delay between amplitude modulation and 5 GHz of frequency chirp. The best performance is provided when there is no delay between the FM and AM, as can be provided using the transmitters described above.

From the results shown in FIGS. 4 and 5 an optimum transmitted signal may have a 5 GHz frequency chirp (at 10 Gb/s) aligned with the amplitude modulation carrying the data. As is well understood, a larger extinction ratio is generally preferable, and the output power should be set as high as possible without causing undesirable non-linear effects in the system. Each of these parameters can be selected and optimised independently using the transmitters described herein, which was not possible with prior art devices.

The ROSNR of the directly modulated laser and amplitude modulator combination is less strongly dependent on CD than a conventional externally modulated CW laser. As noted previously, ROSNR for an externally modulated CW laser is strongly dependent on system CD making optical dispersion compensation difficult to implement. The reduced dependence of the transmitters described herein increases the option to utilise optical dispersion compensation to improve system performance.

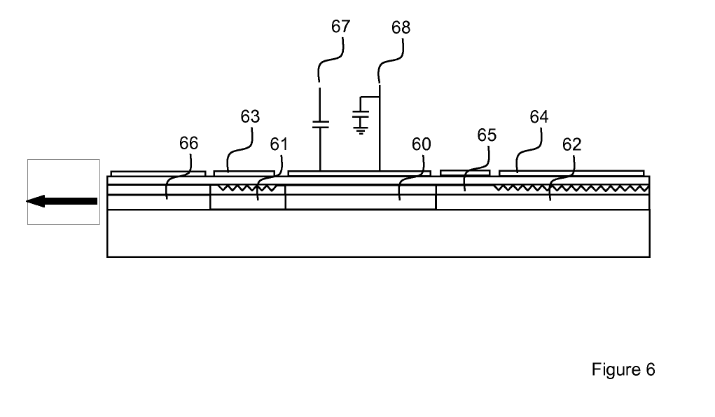

As noted above the previous methods of providing frequency modulation are particularly difficult to implement with a tunable laser source. A schematic diagram of an example of a modified tunable laser is shown in FIG. 6. It should be noted that other types of tunable laser exist, but that in general the same issues arise as discussed here. For example, there is a Y-junction tunable laser which has passive grating sections in the two arms of the laser, and a gain and phase tuning section in the single arm of the ‘lower part’ of the ‘Y’. The tunable laser of FIG. 6 applies the principles described previously in respect of fixed wavelength lasers to allow the independent generation of frequency chirp and amplitude modulation in a tunable laser.

An active gain region 60 is located between two passive grating regions 61, 62. One or both of the gratings 61, 62 are tunable such that the lasing frequency of the device can be tuned by the application of signals to contacts 63, 64. A phase adjustment region 65 is also provided to ensure the correct cavity round-trip phase change is maintained at close to an integral multiple of 2π radians when the gratings are tuned. A Semiconductor Optical Amplifier 66 is provided at the output of the device to increase the output power, but may be omitted if the laser itself can generate sufficient output power.

The tunable grating regions 61, 62 allow tuning of the wavelength of the device, but that tuning is generally relatively slow, and would not be capable of providing frequency chirp at the bit rate as discussed above. The relatively slow speed of response results from the absence of stimulated emission in these passive tuning sections. However, a modulation input 67 is provided to the active region, in addition to DC bias input 68, to allow modulation of the drive current. As has been described previously, that modulation provides the required frequency chirp without also imparting excessive amplitude modulation. The required frequency chirp (50% of the bit rate) is relatively small (5 GHz for a 10 Gbit/s signal), and is unlikely to significantly affect the operation of the tunable laser. This is because the required frequency chirp is expected to be small compared with the separation of the peaks in the combined grating periodic reflection spectrum.

The tunable laser may be used as the laser in the transmitters described above.

As will be appreciated, the amplitude modulator may be provided using any appropriate technology, depending on the specific requirements and design considerations of the system. For example a Mach-Zehnder modulator may be preferred on account of its broad band modulation capability. An electro-absorption modulator is intrinsically a narrow band modulator, on account of its operation near to the semiconductor absorption edge, and is generally not suitable for use with a broad band tunable laser. Waveguide-based Mach-Zehnder modulators may be particularly attractive as they may provide cost reductions by allowing integration of the laser and modulator in a single package or chip. It may also be possible to integrate control electronics with the optical components thereby providing further cost reduction. The use of the term ‘external modulator’ is not intended to convey any particular location or physical property on the modulator, but only that it is external to the laser cavity. For example, the modulator may be provided by a physically separate device coupled to the laser by fibre, by a device incorporated into the same package as the laser using hybrid integration techniques, or by a device monolithically integrated with the laser.

As has been described above, frequency modulation can be provided by modulation of the laser current. However, in order to avoid excessive inter-pulse transient ringing effects the bias current must be relatively high, so that the laser is well above threshold even in the ‘0’s. This implies a low extinction ratio if the modulation current is set by the required adiabatic frequency chirp. In the foregoing description, this has been addressed by the use of an amplitude modulator to increase the modulation depth of a directly modulated laser.

The extinction ratio of a directly modulated laser, modulated to give a 50% frequency chirp, can be increased by operating at a lower bias current, but this increases transient ringing effects which will limit the dispersion tolerance of the system. With a conventional directly modulated laser it is not possible to strike an appropriate compromise between adiabatic frequency chirp, and limited transient ringing. The concept introduced here has been to operate at low extinction ratio in the laser, with the appropriate frequency chirp and weak transient effects and to subsequently increase the extinction ratio in the modulator.

The relationship between applied current and output frequency for a laser is defined, in part, by the Line-width Enhancement Factor (LEF) of the laser. A reduction in the LEF reduces the frequency chirp for a given change in current, and a larger modulation current is then required to produce a 50% frequency chirp. The extinction ratio is thus increased at a given bias current, or the bias current can be increased for a particular extinction ratio compared to a laser with a higher LEF. The adiabatic frequency chirp is approximately proportional to the LEF and the magnitude of the modulation current.

A directly modulated laser with a lower LEF can therefore be utilised to provide a transmitted optical signal having a 50% adiabatic frequency chirp, but with a higher bias current and output power, and a similar extinction ratio compared to prior art devices, without increasing the transient ringing effects.

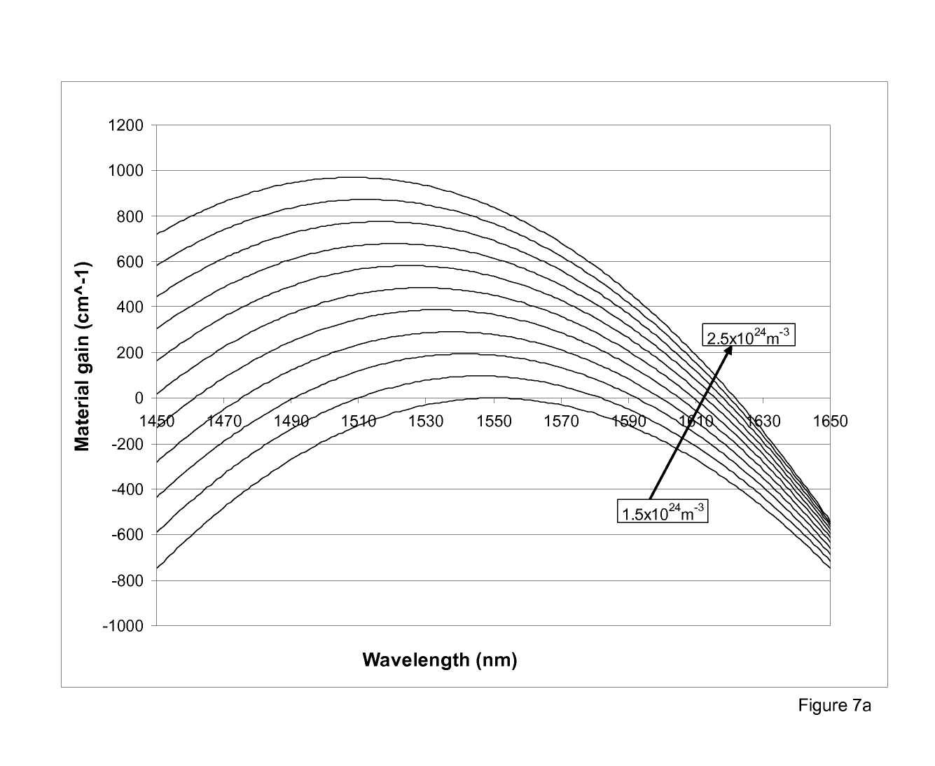

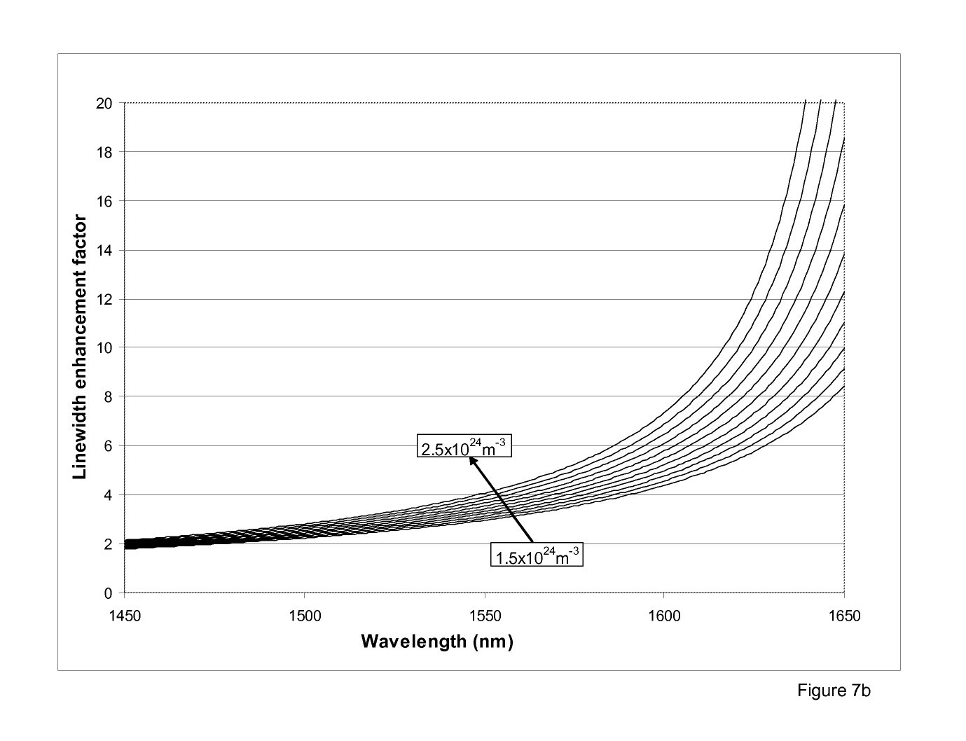

FIG. 7 shows graphs of (a) material gain versus wavelength, and (b) LEF versus wavelength, for carrier densities varying from 1.5×10²⁴ m⁻³ to 2.5×10²⁴ m⁻³ in steps of 1.0×10²³ m⁻³, using a simplified model of the material properties. As shown by these graphs, detuning the lasing wavelength of the laser relative to the material gain peak, to shorter wavelengths, reduces the LEF of the laser. Such a detuning may be achieved by shortening the pitch of the grating in a DFB laser while retaining the gain region design for a longer wavelength laser.

Where references have been made herein to the bit rate and to the adiabatic frequency chirp being 50% of the bit rate, it will be appreciated that if a higher order modulation scheme is utilised, those references should be read as references to symbol rate or baud, not bit rate.

Where references have been made to particular bit rates, it will be appreciated that they are references to the nominal bit rate of the channel and are not intended to restrict the disclosure to that particular number. For example, a nominal 10 Gb/s optical channel operating according to the OC-192 standard has a bit rate of 9953.28 Mb/s but is considered a 10 Gb/s channel. The particular transmission system being utilised may also affect the actual bit rate of the channel compared to the data rate. For example, Forward Error Correction (FEC) may require the addition of information to the actual data, and thus to maintain a given data rate, the channel rate may be increased.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to an item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of generating a signal in an optical transmitter comprising a directly modulated laser and an amplitude modulator for modulating the output of the laser, the method comprising:
applying to a current of the laser a first modulation signal representing data to be transmitted such that an output frequency of the laser is modulated; and
applying a second modulation signal representing the data to be transmitted to the amplitude modulator such that the amplitude of the laser output is modulated.

2. The method according to claim 1, wherein the second modulation signal is delayed compared to the first modulation signal.

3. The method according to claim 1, wherein the first and second modulation signals are the same signal.

4. The method according to claim 1, wherein the first modulation signal is configured to cause a frequency chirp of half a bit rate at which the transmitter is operating.

5. The method according to claim 4, wherein the bit rate is at least 10 Gb/s and the frequency chirp is approximately 50% of the bit rate.

6. The method according to claim 1, wherein the first and second modulation signals are configured such that the optical frequency modulation and amplitude modulation of the output of the amplitude modulator are substantially aligned in time.

7. The method according to claim 1, wherein the first modulation signal is a current waveform and the second modulation signal is a voltage waveform.

8. A transmitter for an optical communications system, comprising:
a directly modulated laser having an input and an output; and
an amplitude modulator having an input and an output, wherein the input of the amplitude modulator is optically coupled to the output of the laser, the output of the amplitude modulator being the output of the transmitter;
wherein the input of the laser is configured to modulate a current of the laser, and the input of the amplitude modulator is configured to modulate amplitude of the output of the laser.

9. The transmitter according to claim 8, wherein the modulation inputs to the laser and the amplitude modulator are configured such that, at the output of the transmitter, frequency modulation applied by the laser is synchronized with amplitude modulation applied by the amplitude modulator.

10. The transmitter according to claim 8, wherein the laser and amplitude modulator are configured as a single package.

11. The transmitter according to claim 8, wherein the inputs to the laser and the amplitude modulator are configured as a single input.

12. The transmitter according to claim 8, further comprising a delay element configured to delay a modulation signal supplied at the input to the amplitude modulator.

13. The transmitter according to claim 8, wherein a bandwidth of the amplitude modulator is at least 50% of a bit rate at which the transmitter is configured to operate.

14. The transmitter according to claim 13, wherein the bandwidth is at least 70% of the bit rate at which the transmitter is configured to operate.

15. The transmitter according to claim 13, wherein the transmitter is configured to operate at least 10 Gb/s.

16. A method comprising:
applying to a directly modulated laser of an optical transmitter, a first modulation signal representing data to be transmitted in order to modulate an output frequency of the laser; and
applying to an amplitude modulator that is coupled to an output of the laser, a second modulation signal representing the data to be transmitted in order to modulate the output of the laser.

17. The method of claim 16, and further comprising delaying the second modulation signal relative to the first modulation signal.

18. The method of claim 16, wherein the first modulation signal is configured to cause a frequency chirp of half a bit rate at which the transmitter is operating.

19. The method of claim 16, and further comprising generating the first and second modulation signals such that optical frequency modulation and amplitude modulation of the output of the amplitude modulator are substantially aligned in time.

20. The method of claim 16, wherein the first modulation signal is a current waveform and the second modulation signal is a voltage waveform.
